(19) United States
(12) Patent Application Publication
(10) Pub. No.: US 2017/0032467 A1
(43) Pub. Date: Feb. 2, 2017

(54) Systems and Methods for Compiling Amounts Spent Through Payment Accounts

(71) Applicant: MASTERCARD INTERNATIONAL INCORPORATED, Purchase, NY (US)

(72) Inventors: Kenneth Unser, Fairfield, CT (US); Serge Bernard, Danbury, CT (US)

(21) Appl. No.: 14/812,378

(22) Filed: Jul. 29, 2015

(51) Int. Cl. G06Q 40/00

(52) U.S. Cl. CPC G06Q 40/12

(57) ABSTRACT

Systems and methods are provided for compiling total amounts spent through payment accounts. One exemplary method includes accessing transaction data associated with a payment account for transactions known to a first payment service provider, and identifying, at a computing device, a first amount spent through the payment account based on the accessed transaction data. The method also includes determining, at the computing device, a second amount spent through the payment account for transactions not known to the first payment service provider, based on at least one predefined factor relating to the transactions known to the first payment service provider. The method then includes aggregating the first amount spent through the payment account and the second amount spent through the payment account.

### FIELD

The present disclosure generally relates to systems and methods for compiling amounts (e.g., money amounts, etc.) spent through payment accounts including, for example, both on-the-books amounts and off-the-books amounts.

### BACKGROUND

This section provides background information related to the present disclosure which is not necessarily prior art.

Consumers often use payment devices in transactions to purchase products (e.g., goods and/or services, etc.) from merchants. Typically, the payment devices are branded by particular payment service providers (e.g., MasterCard®, Visa®, etc.) that process the transactions made with their branded payment devices to appropriate payment accounts. Sometimes, transactions made with payment devices branded by a particular payment service provider are processed by other providers, or are processed directly between issuers, acquirers, or other entities. In these cases, transaction data associated with the transactions are not communicated through, or received by, the particular payment service provider branded on the payment devices.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in compiling amounts spent through payment accounts;

FIG. 2 is a block diagram of a computing device, that may be used in the exemplary network of FIG. 1; and

FIG. 3 is an exemplary method for compiling amounts spent through a payment account for a consumer, in connection with the system of FIG. 1.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers use payment devices, associated with corresponding payment accounts, to purchase products (e.g., goods and/or services, etc.) from merchants. The payment devices are usually branded by particular payment service providers (e.g., MasterCard®, Visa®, etc.) who often process transactions made with the particular payment devices to appropriate payment accounts. In some cases, however, transactions made with branded payment devices are processed by other providers or are processed independent of any such providers. In these cases, transaction data associated with the transactions are not communicated through, or received by, the payment service providers branded on the payment devices. Consequently, when the payment service providers branded on the payment devices (or other parties that may receive transaction data from the providers) analyze spending amounts to the payment accounts, transaction data associated with the spending amounts (and thus the spending amounts themselves) may be incomplete.

The systems and methods described herein identify amounts spent through payment accounts on transactions known to the payment service providers, and then aggregate those amounts with projected amounts spent through the payment accounts on transactions not known to the providers (e.g., projected based on the known amounts spent, etc.). In this manner, estimates of the total amounts spent through the payment accounts, by consumers, for example, can be determined when analyzing consumer spending, etc.

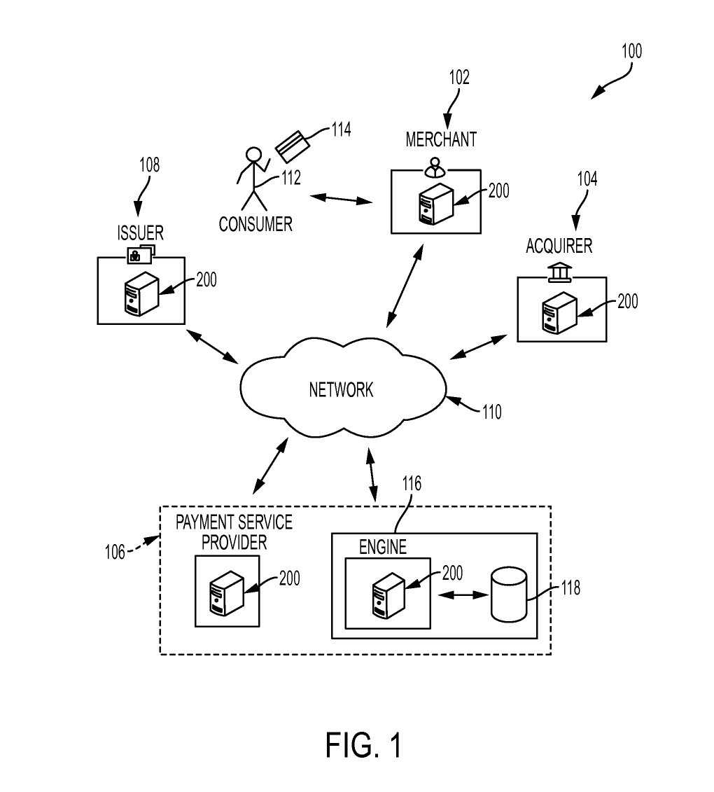

FIG. 1 illustrates an exemplary payment network system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components in the exemplary embodiments, processing of purchase transactions in the exemplary embodiments, etc.

As shown in FIG. 1, the illustrated system 100 generally includes a merchant 102 an acquirer 104, a payment service provider 106, and an issuer 108, each coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 110 includes multiple networks, where different ones of the multiple networks are accessible to different ones of the illustrated components in FIG. 1.

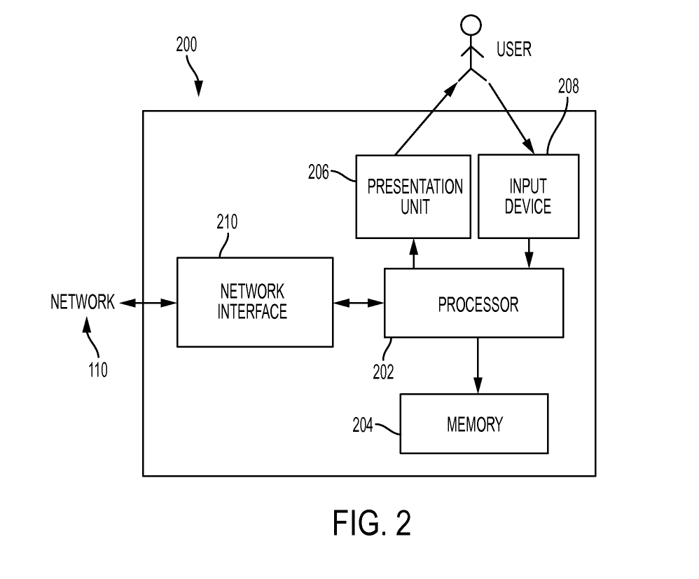

In addition, each of the merchant 102, the acquirer 104, the payment service provider 106, and the issuer 108 in the system 100 is associated with, or implemented in, one or more computing devices. For illustration, the system 100 is described with reference to exemplary computing device 200, illustrated in FIG. 2. And, each of the merchant 102, the acquirer 104, the payment service provider 106, and the issuer 108 in the system 100 is associated with such a computing device 200. However, the system 100 and its components should not be considered limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices, etc.). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 110, or separate therefrom.

With reference to FIG. 2, the illustrated computing device 200 generally includes a processor 202, and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, data relating to payment accounts, transaction data for transactions processed to the payment accounts, factors used to determine amounts spent through the payment accounts, aggregated amounts spent through the payment accounts, offers that can be made to consumers (e.g., to consumer 112 in system 100, etc.) relating to products and/or services for the consumers based on the factors and/or based on the aggregated amounts spent through their payment accounts, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 112 in the system; individuals associated with one or more of the merchant 102, the acquirer 104, the payment service provider 106, and the issuer 108 in the system 100; etc.) by, for example, displaying, audibilizing, and/or otherwise outputting data such as, but not limited to, data relating to payment accounts, transaction data for transactions processed to the payment accounts, factors used to determine amounts spent through the payment accounts, aggregated amounts spent through the payment accounts, product and/or service offers that can be made to consumers, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, a point of sale (POS) terminal, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 110. In some exemplary embodiments, the computing device 200 includes the processor 202 and one or more network interfaces incorporated into or with the processor 202.

By way of example (and without limitation), the exemplary computing device 200 may include one or more servers, personal computers, laptops, tablets, PDAs, telephones (e.g., cellular phones, smartphones, other phones, etc.), POS terminals, combinations thereof, etc. as appropriate.

Referring again to FIG. 1, the system 100 further includes consumer 112, who transacts with the merchant 102 for the purchase of goods and/or services. The transactions may occur in-person at a location associated with the merchant 102, or remotely via telephonic, network, or other connections between the merchant 102 and the consumer 112 (e.g., via network 110, etc.). In order to process these purchase transactions, typically, the merchant 102 must enroll with the payment service provider 106 (e.g., through the acquirer 104, etc.), which then coordinates approval, settlement, etc. of the transactions through the system 100. While only one merchant 102, acquirer 104, issuer 108, and consumer 112 are shown in FIG. 1, it should be appreciated that a different number of one or more of these entities may be included in other embodiments.

In the system 100, the merchant 102, the acquirer 104, the payment service provider 106, and the issuer 108 cooperate to process a request from the consumer 112 to complete a transaction with the merchant 102, via a payment device 114. The payment device 114 is associated with a payment account provided to the consumer 112 by the issuer 108, and through which funds are made available to the consumer 112 for use in the transaction. In addition in the system 100, the payment device 114 is branded by the payment service provider 106, who processes the transaction between the consumer 112 and the merchant 102 to the consumer's payment account.

In the exemplary embodiment, the consumer 112 initiates the transaction by presenting the payment device 114 to the merchant 102. The merchant 102 reads payment account information associated with the payment device 114 and communicates, via the network 110, an authorization request to the payment service provider 106, through the acquirer 104 (associated with the merchant 102), to process the transaction. The authorization request includes various details of the transaction (e.g., transaction data, etc.) to help facilitate processing the authorization request. The payment service provider 106, in turn, communicates the authorization request to the issuer 108 (associated with the consumer's payment account). The issuer 108 then provides an authorization response (e.g., authorizing or declining the request) to the payment service provider 106, which is provided back through the acquirer 104 to the merchant 102. The transaction with the consumer 112 is then completed, or not, by the merchant 102, depending on the authorization response. Other transactions in the system 100, involving the consumer 112 and the merchant 102 (or involving the consumer 112 and other merchants accommodated by the system 100 but not shown) are also processed in a similar manner.

The payment device 114 used by the consumer 112 may include any suitable device such as, for example, a payment card (e.g., a credit card, a debit card, a pre-paid card, etc.), another payment device (e.g., a fob, a smartphone, etc.), or an enabled device through which login credentials for a previously established purchase account can be entered (e.g., to enable use of an electronic wallet such as MasterPass™, Google Wallet™, PayPass™, Softcard®, etc.), etc. Typically, when the payment device 114 is a credit card, a signature from the consumer 112 is required to verify the account (i.e., that the consumer 112 is the authorized user of the payment account). Alternatively, when the payment device 114 is a debit card or a pre-paid card, either a signature or a personal identification number (PIN) from the consumer 112 may be used to verify the account.

Transaction data is generated as part of the above interactions among the merchant 102, the acquirer 104, the payment service provider 106, the issuer 108, and the consumer 112. Depending on the transaction, the transaction data is transmitted from the merchant 102 to the issuer 108 through the payment service provider 106 or otherwise (e.g., as part of the authorization request, etc.). The transaction data may include, without limitation, the PAN for the consumer's payment account involved in the transaction, a payment amount for the product(s) and/or service(s) involved in the transaction, identifier(s) for the product(s) and/or service(s) involved in the transaction, description(s) of the product(s) and/or service(s) involved in the transaction, a merchant name for the merchant 102 involved in the transaction, a merchant identification number (MID) for the merchant 102, a merchant category code (MCC) assigned to the merchant 102 (e.g., by the payment service provider 106 or by another payment service provider, based on a type of products and/or services provided by the merchant 102, etc.), a date and/or time of the transaction, a location of the transaction, etc.

Once generated, the transaction data is stored in one or more different components of the system 100. In the illustrated embodiment, for example, the payment service provider 106 collects the transaction data and stores it in memory 204 of computing device 200 associated with the payment service provider 106 (e.g., in a data structure associated with the memory 204, etc.). As such, the payment service provider 106 includes, in the memory 204, a compilation of consumers and merchants involved in the various transactions processed by (and, thus, known to) the payment service provider 106 (through the system 100, etc.), and the corresponding transaction data for the transactions. Further, the transaction data can be stored by the payment service provider 106, in the memory 204, in various different manners, for example, according to one or more of the payment accounts used by the consumer 112, the merchant(s) involved in the transactions (e.g., the MID for the merchant 102 involved, the MCC for the merchant 102 involved, etc.), or any other criteria, such that the transaction data is readily usable as described herein. It should be appreciated that the same or different transaction data may be collected and stored within other components of the system 100. In addition, while the transaction data is described as stored in the memory 204 of the computing device 200 associated with the payment service provider 106, it should be appreciated that the transaction data could be stored apart from the memory 204 (e.g., in data structures associated with the payment service provider 106 but apart from the computing device 200, etc.) in various implementations.

Other transactions may be performed by the consumer 112 using the payment device 114 outside of the payment network system 100. Here, the transactions may be processed in a similar manner to the above example transaction, but may involve one or more payment service providers different from the payment service provider 106 (and, in some embodiments, one or more other acquirers and/or issuers). Or, the transactions may not be processed by a payment service provider at all, for example, when the acquirer 104 and the issuer 108 are the same entity (e.g., “on-us” or “off-us” transactions, etc.). In connection with these other transactions, the issuer 108 associated with the consumer's payment device 114 or the acquirer 104 associated with the merchant 102 at which the transaction was performed (e.g., when the acquirer 104 is also the issuer 108 of the payment device 114, etc.) often reports transaction data (e.g., in aggregated form, etc.) to the payment service provider 106 for the transactions (e.g., as part of a required reporting function between the issuer 108 and the payment service provider 106 in connection with the branding of the payment device 114 by the payment service provider 106, etc.), such that many of these other transactions are also known to the payment service provider 106. Following such reporting, the payment service provider 106 stores the transaction data in memory 204 of computing device 200 associated with the payment service provider 106, as described above (e.g., in a data structure associated with the memory 204, etc.).

In various exemplary embodiments, consumers (e.g., the consumer 112, etc.) involved in the different transactions herein agree to legal terms associated with their payment accounts, for example, during enrollment in their accounts, etc. In so doing, the consumers may agree, for example, to allow merchants, issuers of the payment accounts, payment service providers, etc. to use data collected during enrollment and/or collected in connection with processing the transactions, subsequently for one or more of the different purposes described herein (e.g., for evaluating spending habits of the consumers, etc.).

With continued reference to FIG. 1, the payment network system 100 also includes an engine 116 configured, often by computer-readable instructions, to, among other functions described herein, compile amounts spent by consumers (e.g., the consumer 112, groups of consumers, etc.) through corresponding payment accounts using payment devices branded, or not, by the payment service provider 106 (e.g., the payment device 114, etc.). In the illustrated system 100, the engine 116 is associated with (e.g., implemented in, etc.) a computing device 200. Also in the illustrated system 100, the engine 116 is a stand-alone entity. However, it is contemplated that the engine 116 could be associated with (or incorporated into) the payment service provider 106 in some implementations (as indicated by the broken lines in FIG. 1). Alternatively, in other embodiments, the engine 116 may be incorporated into other entities, for example, shown in the system 100 (e.g., the acquirer 104, the issuer 108, etc.), or not shown.

With application to consumer 112 and the payment device 114 (and the related payment account), the engine 116 initially identifies spending (e.g., amounts spent, etc.) by the consumer 112 through his/her payment account for transactions known to the payment service provider 106 (i.e., on-the-books spending). In particular, the engine 116 accesses, via the network 110, the transaction data associated with the consumer's payment account from the memory 204 of the computing device associated with the payment service provider 106, for all of the consumer's transactions known to the payment service provider 106. The on-the-books amount spent by the consumer 112 (e.g., a first amount, etc.) can then be identified and aggregated, by the engine 116, from the accessed transaction data.

The engine 116 then determines, or projects (or forecasts), spending (e.g., an amount spent, etc.) by the consumer 112 (e.g., a second amount, etc.) through his/her payment account for transactions not known to the payment service provider 106 (i.e., off-the-books spending). In particular, and as will be described more in connection with method 300, the engine 116 makes use of various predefined factors, stored in data structure 118, to correlate transaction data for the consumer's known transactions (i.e., the consumer's on-the-books spending) to the amount spent by consumer 112 in connection with the transactions not known to the payment service provider 106 (i.e., the consumer's off-the-books spending). This amount can then be aggregated with the amount spent by the consumer 112 for the known transactions to compile a total amount (or value) spent by the consumer 112 through his/her payment account. In various aspects, confidence intervals may be used in connection with the amounts projected for off-the-books spending (and, thus, for the compiled amounts of total spending). For example, ranges of amounts may be expressed when giving the forecasts, for example, +/−10%, +/−$25, etc. The confidence intervals may be calculated as part of employing one or more of the statistical techniques described herein, or others.

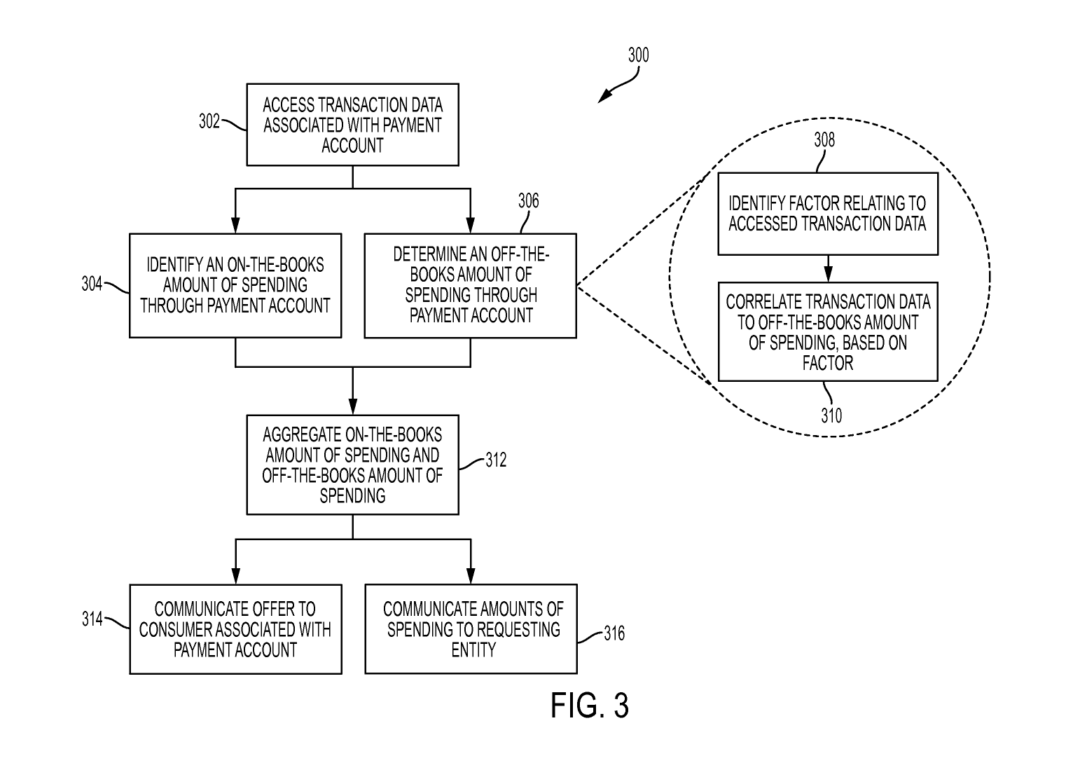

FIG. 3 illustrates exemplary method 300 for use in compiling an amount spent (e.g., an amount of money spent, etc.) through a payment account. The exemplary method 300 is described as implemented in the engine 116 of the payment network system 100, with it understood that the engine 116 is capable of performing one or more of the various operations of the method 300. Further reference is also made in the following description to the merchant 102, the acquirer 104, the payment service provider 106, the issuer 108, and the consumer 112. However, the method 300 could be implemented in one or more other entities, in other embodiments. Further, for purposes of illustration, the exemplary method 300 is described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the method 300, with application to the consumer 112, the engine 116 initially accesses the transaction data associated with the consumer's payment account, at 302, for transactions known to the payment service provider 106 (e.g., for transactions processed directly by the payment service provider 106 through the system 100, for transactions not processed by the payment service provider 106 but reported to the payment service provider 106, etc.). This includes accessing (and, in some implementations, retrieving) the transaction data, for the consumer 112, from the memory 204 of the computing device 200 of the payment service provider 106 (e.g., via network 110, etc.), for example, for all transactions by the consumer 112 over a predefined interval (e.g., the last month, the last three months, the last six months, the last year, the last two years, etc.), etc. In other embodiments, it should be appreciated that different transaction data may be accessed (e.g., all transaction data for a consumer 112, all transaction data for a payment account, all transaction data for a group of payment accounts, etc.). It should also be appreciated that, in some embodiments, the engine 116 may access transaction data from other payment service providers (e.g., in other payment network systems, etc.), in addition to the payment service provider 106, such that multiple sources of transaction data may be accessed.

In some implementations of the method 300, the accessed transaction data, and the transactions associated therewith, may also be categorized by the engine 116 for subsequent use. This may include, for example, assigning a category to the transaction data based on one or more of percentages of the amount spent for particular transactions through the consumer's payment account based on a total amount spent through the consumer's payment account on known transactions, transaction activity types for the transactions (e.g., credit transactions, debit transactions with signature verification, debit transactions with PIN verification, etc.), industries relating to the transactions, consumer identities, data relating to merchants involved in the transactions (e.g., merchant names, MCCs, MIDs, etc.), etc. In addition, in some implementations of the method 300, the consumer 112, and the consumer's corresponding payment account, may also (or alternatively) be categorized based on one or more characteristics of the consumer 112 (e.g., based on demographic data associated with the consumer 112, etc.), or on any other characteristics identified herein.

From the accessed transaction data, the engine 116 then identifies, at 304, an on-the-books (or first) amount spent through the consumer's payment account, for the transactions known to the payment service provider 106. In the method 300, the on-the-books amount includes an aggregate of all spending through the consumer's payment account on transactions known to the payment service provider 106, as identified from the accessed transaction data. As previously described, this includes, for example, the amount for transactions processed directly by the payment service provider 106 through the system 100, for transactions not processed by the payment service provider 106 but reported to the payment service provider 106, etc. In other embodiments, the on-the-books amount may include less than all amounts spent through the consumer's payment account on transactions known to the payment service provider 106. For example, the on-the-books amount may include (or may be limited to) all spending through the consumer's payment account on transactions known to the payment service provider 106 and categorized in a particular industry, made during a particular interval, associated with a particular MCC, or limited in any other desired manner, etc.

Next, at 306, the engine 116 determines an off-the-books (or second) amount spent through the consumer's payment account, for transactions not known to the payment service provider 106. As part of this operation, the engine 116 identifies factors (e.g., data relationships, etc.) from the data structure 118 that relate to the accessed transaction data at 308, and then uses the factors (e.g., in connection with one or more statistical methods such as clustering, correlation, regression, decision trees, indexing, etc.) to compare, at 310, the transaction data for the consumer's payment account known to the payment service provider 106 to the off-the-books amount. In the method 300, the factors are predefined, for example, by the engine 116 and are stored in the data structure 118. However, in other embodiments, the factors may be generated on-the-fly inside purpose built software, etc.

Example factors that may be used, by the engine 116, in connection with determining the off-the-books amount spent through the consumer's payment account include, without limitation, ratios of different transaction activity types for the consumer 112 by industry, merchant, etc. (e.g., a ratio of transactions by the consumer 112 using signature verification to transactions using PIN verification, etc.); percentages of different tender used by the consumer 112 in the known transactions (e.g., a percentages of cash transactions made by the consumer 112 through the consumer's payment account, a percentage of credit card transactions made by the consumer 112 through the consumer's payment account, a percentage of debit card transactions made by the consumer 112 through the consumer's payment account, etc.); numbers of co-branded or store cards issued to consumer 112; reward incentives used by the consumer 112 (e.g., a cash-back reward incentive used on transactions for gas, etc.); total revenue generated by the merchant 102 (or other merchants) from whom the consumer 112 purchased products and/or services (e.g., categorized by payment type, etc.); an identification of the merchant 102 (or of other merchants) for which the issuer 108 and the acquirer 104 are the same entity; an identification of the merchant 102 (or of other merchants) for which the acquirer 104 also issues a merchant store card; an identification of the merchant 102 (or of other merchants) for which the issuer 108 also issues one or more co-branded cards; etc.

In addition, it should be appreciated that the factors used by the engine 116 in connection with determining the off-the-books amount of spending may be formulated based on data reported to, collected by, etc. the engine 116 from various different sources including, for example, firmographic data, consumer data, etc. Firmographic data may include, without limitation, revenue data for the merchant 102 (or for other merchants), indicators of payment types used by consumers at the merchant 102 (or at other merchants), etc. And, consumer data may include, without limitation, data collected by third party aggregators about individual consumers and/or groups of consumers, data provided directly by consumers to the engine 116 or to third-party collectors (e.g., via paid panels or surveys, etc.), data provided by the issuer 108 and related to the consumer 112, data provided by issuers of other payment devices relating to other consumers (on an individual level or on a group level), data provided by demographic vendors (e.g., demographic data relating to age, income, education, geography, presence of children, etc.), data relating to total amounts spent by consumers using payment devices branded by the payment service provider 106 (for transactions known to the payment service provider 106) versus transactions (e.g., a total number of transactions, a total number of transactions per industry, etc.) processed by the payment service provider 106, data relating to the amount spent by the consumer 112 (or by other consumers individually or as a group) by payment type, attitudinal data for the consumer 112 or for other consumers (e.g., payment account verification preferences (e.g., signature verses PIN, etc.) for the consumer 112 or for other consumers, in general, or by industry, or by merchant, etc. (and related circumstances), etc.).

As an example, transaction data for a consumer is available to the engine 116, via the payment service provider 106, for all transactions made by the consumer with his/her debit card using signature verification. However, transaction data is not available for the consumer for transactions using PIN verification (as these transactions are not processed by the payment service provider 106 through the payment network system 100 in this example). The available transaction data also indicates, to the engine 116, that the consumer prefers using PIN verification for his/her payment account, and that the consumer only chooses signature verification in cases where PIN verification is not available (e.g., at restaurants or other locations know to the engine 116, generally, not to have PIN-pad devices, etc.). As such, in connection with determining an off-the-books amount spent by the consumer in this example, the engine 116 identifies factors, from the data structure 118, relating to payment account verification. And, in connection therewith, the engine 116 identifies (and selects) a factor relating to spending at restaurants (based on the consumer's preference for PIN verification, and based on total amounts spent by other consumers having similar preferences), and uses the factor to extrapolate the off-the-books amount spent by the consumer, through his/her payment account, for transactions using PIN verification. In some implementations, selection of the factor may also be based on categories assigned to the transactions and/or the consumer.

As another example, a consumer may frequently use a credit card, branded by the payment service provider 106, to purchase products and/or services from a particular merchant. However, in this example, an issuer of the credit card also acts as an acquirer for the merchant. And, the acquirer processes all transactions made by the consumer at the merchant, using the credit card, independent of the payment service provider 106 (and independent of the payment network system 100) (e.g., as on-us transactions, etc.). As such, transaction data for the transactions by the consumer at the merchant, using the credit card, is not available to the payment service provider 106 (or the engine 116). With that in mind, in connection with determining an off-the-books amount spent by the consumer in this example, the engine 116 identifies a factor, from the data structure 118, relating to transactions at the merchant by other consumers having similar demographics to the consumer and also having payment devices branded by the payment service provider 106 but issued by other issuers. Using this factor, the engine 116 then projects how much the consumer spends at the merchant.

As another example, Bank A is an acquirer for a major home improvement chain, Acme Tools, as well as an issuer of payment devices to consumers branded by the payment service provider 106. On-the-books spending for Bank A, to the payment service provider 106, in the home improvement industry is $9,000,000. Bank B is an issuer of payment devices to consumers branded by the payment service provider 106. The payment service provider 106 has no transaction data for payment devices issued by Bank A at Acme Tools (e.g., because Bank A uses “on-us” processing of the transactions, etc.). As such, when desired to determine spending at Acme Tools by consumers using payment devices issued by Bank A, the engine 116 identifies, as a first factor, from transaction data for consumers having payment devices issued by Banks A and B (via the payment service provider 106), that a portfolio of the payment devices (and corresponding payment accounts) issued by Bank B have spending behaviors similar to those issued by Bank A. The engine 116 also identifies, as a second factor, that transactions at Acme Tools, by consumers using the payment devices issued by Bank B (which transactions are processed by the payment service provider 106), represent 25% of all home improvement spending processed by the payment service provider 106. Using these two factors, the engine 116 can project that consumers using the payment devices issued by Bank A also spend $3,000,000 at Acme Tools. The engine 116 can then further project that consumers using the payment devices issued by Bank A spend a total amount of $12,000,000 in the home improvement industry.

As still another example, on-the-books spending by consumers using particular debit cards branded by the payment service provider 106 may be $2,000,000. From consumer survey data (or from other data), the engine 116 is aware, as a factor, that only 20% of all transactions made by the consumers using the particular debit cards are processed through the payment service provider 106 (e.g., are known to the payment service provider 106, etc.). Based on this factor, the engine 116 can project that consumers using the particular debit cards spend a total amount of $10,000,000.

In a further example, consumers Jim and Joe are both 25-year old males living in New York City, N.Y. Jim prefers processing purchase transactions at restaurants made with his debit card (branded by the payment service provider 106), while Joe prefers processing payment transactions at restaurants with his debit card (also branded by the payment service provider 106) as credit transactions. On-the-books spending by Jim, on average, is $200 per month at restaurants (e.g., based on MCC, etc.) using his debit card. And, on-the-books spending by Joe is $100 per month at restaurants using his debit card. From transaction data accessed by the engine 116, from the payment service provider 106, the engine 116 identifies, as a first factor, that on-the-books spending for Joe, using his debit card, is $300 and, as a second factor, that this amount is a total spend amount for Joe (i.e., Joe has confirmed, through survey data or otherwise, that he processes all transactions using his debit card as credit transactions). Using these factors, relating to Joe's total spending using his debit card, the engine 116 can project that Jim's total spending using his debit card is $600.

With continued reference to FIG. 3, at 312, the engine 116 aggregates the on-the-books amount spent through the payment account and the off-the-books amount spent through the payment account. In so doing, the engine 116 compiles a total amount spent by the consumer through the payment account.

Also in the method 300, the engine 116 may communicate an offer to the consumer, at 314, based on one or more of the amounts spent by the consumer through the payment account. For example, when the engine 116 indicates that the off-the-books amount spent by the consumer includes numerous transactions using PIN verification, the engine 116 may communicate an offer to the consumer with an incentive for the consumer to select signature verification of his/her payment account for future transactions, instead of PIN verification (e.g., so that the future transactions can be processed by the payment service provider 106 through the payment network system 100, etc.). Other offers may include incentives for the consumer to transact with particular merchants that are enrolled with the payment service provider 106 (such that the resulting transactions are processed through the system 100), or incentives for the consumer to use particular payment devices (e.g., credit cards verses debit cards, etc.), etc.

In addition, or alternatively, at 316, the engine 116 may communicate one or more of the amounts spent by the consumer to a requesting entity or group of entities. For example, the payment service provider 106 may desire to add industries and/or merchants to the payment network system 100 for accepting payment devices branded by the payment service provider 106. As such, the payment service provider 106 may submit a request to the engine 116 to determine off-the-books amounts spent by consumers on transactions relating to the particular industries and/or merchants, using payment devices branded by the payment service provider 106. In response, after determining the requested amounts spent, the engine 116 communicates the desired information back to the payment service provider 106 for use in determining which industries and/or merchants present the most opportunity for expansion.

In an example application of the method 300 (in connection with the payment network system 100), the engine 116 initially compiles data, via a survey, relating to both on-the-books and off-the-books amounts spent by a sample group of consumers using their debit cards. From this data, the engine 116 observes that the spending behavior of the consumers that prefer using PIN verification for their transactions to signature verification is fairly consistent in terms of ratios of amounts spent by the consumers, by industry. In essence, for the surveyed group of consumers, payment account verification preference does not seem to correlate with spending activity.

In this example application, the payment service provider 106 may be able to process most of the transactions by consumers that use signature verification of their payment accounts, but may only be able to process a small portion of the transactions by the consumers that use PIN verification. And, from the transaction data collected by the payment service provider 106 for the transactions using signature verification, the engine 116 may be able to determine whether a particular consumer, that uses a debit device branded by the payment service provider 106, prefers using PIN verification of his/her payment account or signature verification. In making this determination, the engine 116 may also determine a ratio of transactions made by the consumer using PIN verification to transactions made by the consumer using signature verification, and assess a likelihood that the consumer will select PIN verification for a transaction or signature verification (e.g., signature verification at a restaurant and PIN verification elsewhere, etc.).

Then in this example, using the survey data compiled by the engine 116 for the sample group of consumers, the engine 116 is able to determine an off-the-books amount spent by the particular consumer for transactions using PIN verification. For example, from the transaction data, the engine 116 observes that the consumer uses signature verification for his/her payment account for table service purchases at restaurants, that are known not to accommodate PIN verification of debit cards. The engine 116 also observes that the consumer uses PIN verification for his/her payment account for all other transactions. From the survey data compiled by the engine 116, for consumers with similar demographics to the consumer and also preferring PIN verification to signature verification, the engine 116 identifies that table service restaurants represent about ten percent of the total amount spent for the consumers. Using this factor, if the engine 116 identifies that an on-the-books amount spent by the consumer at table service restaurants is $50, the engine 116 can determine that the off-the-books amount spent by the consumer is about $450.

The systems and methods herein are described in connection with compiling amounts spent by a consumer through his/her payment account. It should be appreciated, however, that the systems and methods could equally be used to compile amounts spent by the consumer through multiple different payment accounts associated with the consumer, or to compile amounts spent by multiple consumers (or particular groups of consumers, such as all consumers within a household, etc.) through a single payment account or through multiple different payment accounts, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) accessing transaction data associated with the payment account for transactions known to a first payment service provider; (b) identifying a first amount spent through the payment account, based on the accessed transaction data; (c) determining, at the computing device, a second amount spent through the payment account for transactions not known to the first payment service provider, based on at least one predefined factor relating to the transactions known to the first payment service provider; and (d) aggregating the first amount spent through the payment account and the second amount spent through the payment account.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for compiling a total amount spent through at least one payment account, the method comprising:
accessing transaction data associated with the at least one payment account for transactions known to a payment service provider;
identifying, at a computing device, a first amount spent through the at least one payment account, based on the accessed transaction data;
determining, at the computing device, a second amount spent through the at least one payment account for transactions not known to the payment service provider, based on at least one predefined factor relating to the transactions known to the payment service provider; and
aggregating the first amount spent through the payment account and the second amount spent through the at least one payment account.

2. The computer-implemented method of claim 1, wherein the accessed transaction data includes transaction data for transactions occurring during a predefined interval.

3. The computer-implemented method of claim 1, wherein the payment service provider is a first payment service provider; and
wherein the accessed transaction data includes transaction data for transactions processed by a second payment service provider.

4. The computer-implemented method of claim 3, further comprising receiving, at the computing device, the transaction data for the transactions processed by the second payment service provider from an issuer associated with the payment account.

5. The computer-implemented method of claim 1, wherein the at least one predefined factor relates to one or more of a mode of payment account verification used in the transactions and a tender type used in the transactions.

6. The computer-implemented method of claim 1, wherein the at least one payment account includes at least two payment accounts.

7. The computer-implemented method of claim 1, further comprising:
assigning a category to the at least one payment account based on one or more characteristics of an entity associated with the at least one payment account; and
selecting the at least one predefined factor, from a data structure comprising multiple predefined factors, based on the assigned category.

8. The computer-implemented method of claim 1, wherein the at least one payment account includes a first payment account; and
further comprising generating the at least one predefined factor based on transaction data for at least a second payment account, different from the first payment account.

9. The computer-implemented method of claim 1, further comprising communicating at least one offer to an entity associated with the at least one payment account, based on the aggregate of the first amount spent through the at least one payment account and the second amount spent through the at least one payment account.

10. A system for use in compiling a total amount spent through a payment account for transactions processed by a payment service provider and for transactions not processed by the payment service provider, the system comprising:
at least one data structure configured to store transaction data for transactions processed to associated payment accounts by the payment service provider, and factors for use in determining money spent through the payment accounts for transactions not processed by the payment service provider; and
an engine coupled to the at least one data structure, the engine configured to:
determine a first amount spent through a payment account, based on transaction data associated with the payment account and stored in the at least one data structure;
compare the first amount spent through the payment account to at least one of the factors stored in the at least one data structure; and
based on the comparison, determine a second amount spent through the payment account for the transactions not processed by the payment service provider.

11. The system of claim 10, wherein at least one of the factors in the at least one data structure relates to a mode of payment account verification used in the transactions; and/or
wherein at least one of the factors in the at least one data structure relates to a tender type used in the transactions.

12. The system of claim 11, wherein at least one of the factors in the at least one data structure further relates to a transaction category of the transactions.

13. The system of claim 10, wherein the transaction data used to determine the first amount spent through the payment account includes transaction data for transactions occurring during a predefined interval.

14. The system of claim 10, wherein the payment service provider is a first payment service provider;
wherein the at least one data structure is further configured to store transaction data for transactions processed to the associated payment accounts by a second payment service provider, different from the first payment service provider; and
wherein the transaction data used by the engine to determine a first amount spent through a payment account includes the transaction data for transactions processed to the associated payment accounts by both the first and second payment service providers.

15. The system of claim 14, wherein the engine is further configured to:
receive the transaction data for the transactions processed to the associated payment accounts by the second payment service provider from an issuer associated with the payment accounts; and
store the received transaction data in the at least one data structure in association with the corresponding payment accounts.

16. The system of claim 10, wherein the at least one data structure is further configured to store multiple offers related to processing transactions to the payment accounts; and
wherein the engine is further configured to:
identify at least one of the multiple offers based on an aggregate of the first amount spent through the payment account and the second amount spent through the payment account; and
communicate the identified at least one of the multiple offers to an entity associated with the payment account.

17. A non-transitory computer readable media including executable instructions which, when executed by at least one processor, cause the at least one processor to:
access transaction data associated with the payment account for transactions processed by a first payment service provider;
determine a first amount spent through the payment account, based on the accessed transaction data;
determine a second amount spent through the payment account for transactions not processed by the first payment service provider, based on at least one predefined factor related to the transactions processed by the first payment service provider; and
aggregate the first amount spent through the payment account and the second amount spent through the payment account.

18. The non-transitory computer readable media of claim 17, wherein the executable instructions, when executed by the at least one processor, further cause the at least one processor to access transaction data associated with the payment account for transactions processed by a second payment service provider different from the first payment service provider;
wherein the first amount spent through the payment account, as determined by the at least one processor, is based on the accessed transaction data for transactions processed by the first and second payment service providers.

19. The non-transitory computer readable media of claim 17, wherein the executable instructions, when executed by the at least one processor, further cause the at least one processor to:
assign a category to the payment account based on one or more characteristics of an entity associated with the payment account; and
select the at least one predefined factor, from a repository of factors, based on the assigned category.

20. The non-transitory computer readable media of claim 17, wherein at least one of the predefined factors relates to a mode of payment account verification used in the transactions;
and/or wherein at least one of the predefined factors relates to a tender type used in the transactions; and/or
wherein at least one of the predefined factors relates to a transaction category of the transactions.
